(19) United States
(12) Patent Application Publication
(10) Pub. No.: US 2025/0310201 A1
(43) Pub. Date: Oct. 2, 2025

(54) METHOD AND APPARATUS FOR SCHEDULING BANDWIDTH OF CLOUD PHONE NETWORK

(71) Applicant: Hunan MC Technology Co., Ltd., Hunan (CN)

(72) Inventors: Yantao MOU, Hunan (CN); Yongce TU, Hunan (CN); Qiang WU, Hunan (CN); Qingyu GUO, Hunan (CN); Jiaxiang GAO, Hunan (CN)

(73) Assignee: Hunan MC Technology Co., Ltd., Hunan (CN)

(21) Appl. No.: 19/240,167

(22) Filed: Jun. 17, 2025

(30) Foreign Application Priority Data
Sep. 14, 2024 (CN) 202411296513.1

(51) Int. Cl. H04L 41/0896

(52) U.S. Cl. CPC H04L 41/0896

(57) ABSTRACT

A method for scheduling a bandwidth of a cloud phone network is provided. The specific implementation includes: sorting current bandwidths of multiple cloud phones in a descending order; in response to detecting that a bandwidth of a switch exceeds a predetermined threshold, generating a speed-limited table based on current bandwidths of a predetermined number of target cloud phones ranked at top of the sorted current bandwidths; and applying speed limits to the target cloud phones according to the speed-limited table

### CROSS-REFERENCE TO RELATED APPLICATIONS

This application claims the priority from Chinese Patent Application No. 202411296513.1, filed on Sep. 14, 2024, and titled “METHOD AND APPARATUS FOR SCHEDULING BANDWIDTH OF CLOUD PHONE NETWORK,” the entire disclosure of which is hereby incorporated by reference.

### TECHNICAL FIELD

The present disclosure relates to the field of cloud services, and more particularly, to the field of cloud phones, and more particularly, to a method and apparatus for scheduling a bandwidth of a cloud phone network.

### BACKGROUND

Currently, for cloud phones, many scenarios require access to both intranet and public networks to download network resources. In data centers, multiple tenants and a large number of cloud phones typically share expensive bandwidth resources. When multiple tenants/users simultaneously initiate downloads, it is common to face the situation where the shared bandwidth reaches its upper limit, leading to network congestion and the inability of all devices to use network services normally.

In related technologies, when bandwidth exceeds a certain threshold, overall rate limiting is usually implemented at the switch level (for a batch of devices). Although this can ensure that the sum of bandwidths of groups is less than the upper limit, it results in low utilization of an individual group while occupying the overall bandwidth value.

### SUMMARY

The present disclosure provides a method for scheduling a bandwidth of a cloud phone network, a device and a storage medium.

According to a first aspect of the present disclosure, there is provided a method for scheduling a bandwidth of a cloud phone network, including sorting current bandwidths of a plurality of cloud phones in a descending order; generating a speed-limited table based on current bandwidths of a predetermined number of target cloud phones ranked at top of the sorted current bandwidths, in response to detecting that a switch bandwidth exceeds a predetermined threshold; and applying speed limits to the target cloud phones according to the speed-limited table.

According to a second aspect of the present disclosure, there is provided an electronic device including at least one processor; and a memory in communication with the at least one processor; where the memory stores instructions executable by the at least one processor to cause the at least one processor to perform the method according to any of the first aspects.

According to a third aspect of the present disclosure, there is provided a non-transitory computer-readable storage medium storing instructions for causing the computer to perform the method according to any of the first aspects.

It should be understood that the description in this section is not intended to identify key or critical features of the embodiments of the disclosure, nor is it intended to limit the scope of the disclosure. Other features of the present disclosure will become readily apparent from the following description.

### BRIEF DESCRIPTION OF THE DRAWINGS

The drawings are for a better understanding of the present disclosure and do not constitute a limitation of the present disclosure.

FIG. 1 is an exemplary system architecture diagram in which an embodiment of the present disclosure may be applied;

FIG. 2 is a flowchart of a method for scheduling a bandwidth of a cloud phone network according to an embodiment of the present disclosure;

FIG. 3 is a schematic diagram of an application scenario of a method for scheduling a bandwidth of a cloud phone network according to the present disclosure;

FIG. 4 is a flowchart of a method for scheduling a bandwidth of a cloud phone network according to another embodiment of the present disclosure;

FIG. 5 is a schematic structural diagram of an apparatus for scheduling a bandwidth of a cloud phone network according to an embodiment of the present disclosure;

FIG. 6 is a schematic structural diagram of a computer system for implementing an electronic device of an embodiment of the present disclosure.

### DETAILED DESCRIPTION OF EMBODIMENTS

The following description of exemplary embodiments of the present disclosure, taken in conjunction with the accompanying drawings, includes various details of embodiments of the present disclosure to facilitate understanding, and is to be considered as exemplary only. Accordingly, one of ordinary skill in the art will recognize that various changes and modifications may be made to the embodiments described herein without departing from the scope and spirit of the disclosure. Also, for clarity and conciseness, descriptions of well-known functions and structures are omitted from the following description.

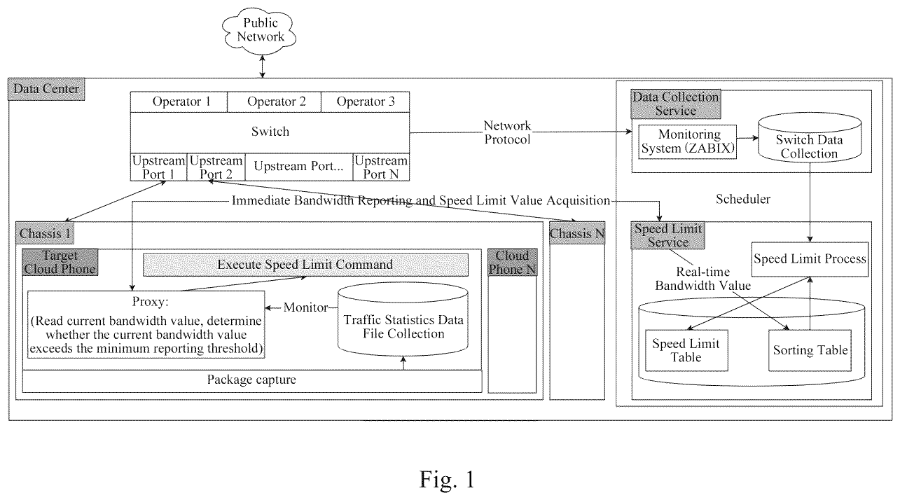

FIG. 1 illustrates an exemplary system architecture in which a method or an apparatus for scheduling a bandwidth of a cloud phone network according to an embodiment of the present disclosure may be applied.

As shown in FIG. 1, the system architecture may include a public network, a computer room, a scheduler, a switch, a chassis, and a cloud phone. Multiple sets of switches belonging to different operators may be installed in one machine room to connect to the public network. Each group of switches may connect multiple chassis. Each chassis may run multiple cloud phones, and a cloud phone that needs to be limited in speed is called a target cloud phone. Each chassis is connected to the switch through an uplink port.

The scheduler may run both the data collection service process and the speed-limiting service process. The data collection service may collect data from switches via network protocols through a monitoring system (such as Zabbix). The cloud phone reports its real-time bandwidth to the speed-limiting service, which generates a sorting table based on real-time bandwidth values. When the timing of limiting speed is reached, the speed-limiting process generates a speed-limiting table according to the sorting table.

The cloud phone may perform data packet capture, and then perform traffic statistics to generate a traffic statistics data file set. An agent may be run on the cloud phone to read the current bandwidth by monitoring the collection of traffic statistics data files. Whether the current bandwidth exceeds the minimum reporting threshold is determined, and if the current bandwidth exceeds the minimum reporting threshold, the current bandwidth is reported to the speed limiting service of the scheduler through the agent. The cloud phone may read the speed limit value from the speed-limited table of the scheduler and execute the speed limit command through the agent.

It should be noted that the method for scheduling a bandwidth of a cloud phone network provided in the embodiments of the present disclosure is generally executed by a scheduler, and accordingly, the apparatus for scheduling a bandwidth of a cloud phone network is generally disposed in the scheduler.

It should be understood that the number of schedulers, switches, chassis, cloud phones in FIG. 1 is merely illustrative. There may be any number of schedulers, switches, chassis, cloud phones, as desired for implementation.

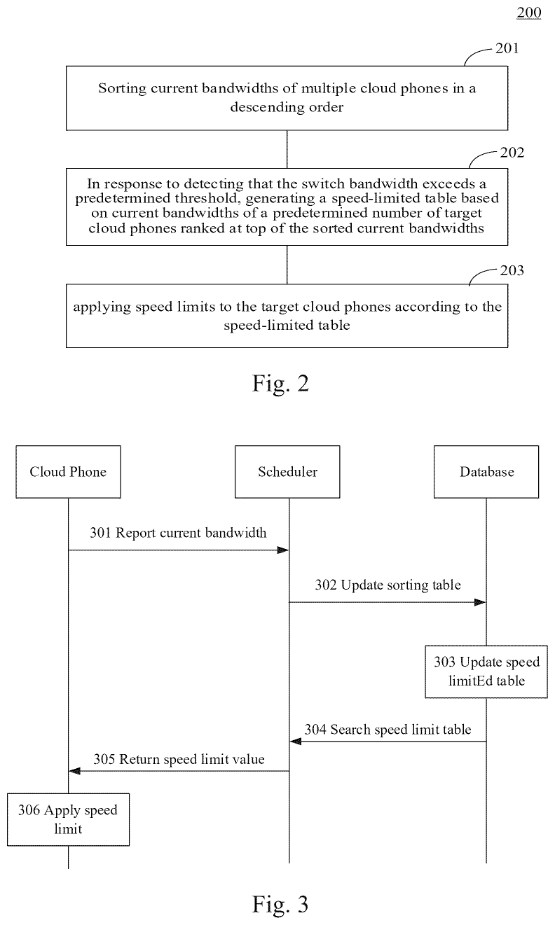

With continuing reference to FIG. 2, a flow 200 of a method for scheduling a bandwidth of a cloud phone network according to an embodiment of the present disclosure is shown. The method for scheduling a bandwidth of a cloud phone network includes the following steps.

Step 201 includes sorting current bandwidths of multiple cloud phones in a descending order.

In the present embodiment, the execution body of the method for scheduling a bandwidth of a cloud phone network (such as the scheduler shown in FIG. 1) may obtain the current bandwidths from multiple cloud phones through a wired connection mode or a wireless connection mode. The current bandwidths of the multiple cloud phones are then sorted in descending order.

Step 202 includes generating a speed-limited table based on current bandwidths of a predetermined number of target cloud phones ranked at top of the sorted current bandwidths, in response to detecting that the switch bandwidth exceeds a predetermined threshold.

In this embodiment, the speed limit may be triggered when the bandwidth of the switch is detected to exceed a predetermined threshold. Instead of applying a unified speed limit to all cloud phones, speed limiting is only applied to some cloud phones with relatively high current bandwidth (i.e., the target cloud phones). Therefore, a speed limit value may be generated based on the current bandwidth of the target cloud phone and then written into the speed-limiting table. The speed limit value may be generated according to certain rules. For example, a fixed speed limit value may be set for a specific bandwidth range, or a speed-limiting ratio may be designed. Multiplying the current bandwidth by the speed-limiting ratio yields the speed limit value. The speed-limiting ratio may be a fixed value or dynamically adjusted based on the current bandwidth. Each switch corresponds to one speed-limiting table. This disclosure may apply speed limiting separately to four types of bandwidths (LAN uplink bandwidth, LAN downlink bandwidth, public network uplink bandwidth, and public network downlink bandwidth), resulting in the generation of four speed-limiting tables. The speed-limiting table is shown in the table below:

| Cloud | | | Current | Speed limit |
|---|---|---|---|---|
| phone | User | Chassis | bandwidth | value |
| ID | ID | ID | (MB/S) | (MB/S) |
| C01 | U39 | B01 | 200 | 160 |
| C02 | U741 | B01 | 300 | 240 |
| . . . | . . . | . . . | . . . | . . . |

Step 203 includes applying speed limits to the target cloud phones according to the speed-limited table.

In this embodiment, the speed limit value in the speed-limited table may be sent to the target cloud phone, and the target cloud phone sets the maximum network speed not to exceed the speed limit value in the speed-limited table through the command carried by the bottom operating system of the cloud phone. Alternatively, the speed-limited table may include only the cloud phone ID and does not include the speed limit value, and only the speed limit instruction is sent according to the cloud phone ID in the speed-limited table, and the cloud phone itself calculates the speed limit value to perform the speed limit. The cloud phone may be set by default to reduce the bandwidth to a certain proportion, for example, 80%, after receiving the speed limit command.

According to the method provided in the above embodiment of the present disclosure, a precise resource management down to the level of individual cloud phones is achieved, and the bandwidth is dynamically allocated to ensure the overall availability. Moreover, the method is automated, eliminating the need for manual intervention.

In some alternative implementations of the present embodiment, sorting the current bandwidths of multiple cloud phones in descending order includes: generating a sorting table based on the current bandwidths of the multiple cloud phones in a descending order. The sorting table and the speed-limited table may be stored together in a database, facilitating data management and saving memory overhead.

In some alternative implementations of the present embodiment, applying speed limits to the cloud phones based on the speed-limited table includes: querying the speed-limited table for a previously speed-limited cloud phone; and in response to not finding any previously speed-limited cloud phones, removing the speed limit from the previously speed-limited cloud phone. Speed limits are applied according to the updated speed-limited table. If a previously speed-limited cloud phone does not appear in the current speed-limited table, the speed limit may be removed. The speed limit may be removed by sending a command to restore the network speed. This allows for timely restoration of bandwidth and does not affect normal services.

In some alternative implementations of the present embodiment, generating a speed-limited table based on the current bandwidths of a predetermined number of target cloud phones ranked at the top includes: mapping the current bandwidths of the target cloud phones to different levels according to predefined ranges, where a higher current bandwidth corresponds to a higher level; calculating the speed-limited values for the target cloud phones by multiplying the current bandwidths by the preset speed-limited ratios for respective levels of the target cloud phones, where the higher level has a higher speed-limited ratio; and generating the speed-limited table based on the speed-limited values of the target cloud phones. For example, for cloud phones with current bandwidth in the top 10%, 20%, and 30%, the speed-limited ratios are set at 80%, 50%, and 30%, respectively. This approach reduces the impact of speed limiting on high-traffic services and ensures a user experience.

In some alternative implementations of the present embodiment, sorting the current speeds of multiple cloud phones in descending order includes: obtaining a list of cloud phones used by non-speed-limited users; identifying the cloud phones requiring speed limiting from the multiple cloud phones based on the cloud phone list; and sorting the current speeds of the speed-limited cloud phones in descending order. A whitelist of users who do not need speed limiting is set up, and speed limiting is only applied to users outside the whitelist. Different permissions may be set for different users to enable targeted speed limiting.

In some alternative implementations of the present embodiment, the sorting table includes user identifiers for the cloud phones; and the method further includes: counting the numbers of respective cloud phones used by users based on the user identifiers; and adjusting the sorting table in a descending order of the numbers of respective cloud phones. The sorting table may be sorted again based on the numbers of cloud phones. The sorting may be performed first by the numbers of cloud phones in descending order, and then the cloud phones of same numbers are sorted by current speeds in descending order. Alternatively, the sorting may be first performed by current speeds in descending order, and then the cloud phones of same speeds are sorted by numbers of cloud phones in descending order.

Alternatively, the first sorting value is obtained by sorting the numbers of cloud phones in descending order, and the second sorting value is obtained by sorting the current bandwidths in descending order. The first sorting value and the second sorting value are weighted and summed to obtain a total sorting value. The cloud phones may be sorted in ascending order of total sorting values. This approach can quickly implement speed limiting and thus accelerate the speed-limiting effect.

In some alternative implementations of the present embodiment, the sorting table includes the priority of services running on the cloud phones; and the method further includes: adjusting the sorting table in ascending order of the priorities of services running on the cloud phones. If multiple services are running on a cloud phone, an average service priority may be calculated. Weighting factors may be assigned to different service priorities, and the second sorting value obtained by sorting the current bandwidths in descending order may be multiplied by the weighting factors to obtain a weighted second sorting value. The weighting factors may be set within the range (0,1], with lower service priorities having smaller weighting factors. This ensures that a smaller weighted sorting value has a higher ranking, meaning that cloud phones with lower service priorities are prioritized for speed limiting. This approach reduces the impact on cloud phones with higher service priorities.

In some alternative implementations of the present embodiment, the method further includes generating a speed-limited table based on the current bandwidths of the predetermined number of target cloud phones ranked at top of the sorted current bandwidths, in response to detecting an arrival of a predicted traffic peak time. This allows for speed limiting not only based on real-time bandwidth but also before the traffic peak arrives, thereby avoiding network congestion due to delayed speed limiting during peak traffic.

In some alternative implementations of the present embodiment, the method further includes backing up the sort table periodically; obtaining the current bandwidths of the plurality of cloud phones and regenerating the sorting table in a descending order of the current bandwidths of the plurality of cloud phones; and removing a sorting table reaching an expiration time. The sorting table needs to be backed up to retain some historical data for troubleshooting. The sorting table also needs to be removed periodically to automatically remove speed limits.

In some alternative implementations of the present embodiment, the generating the sorting table in descending order of the current bandwidths of the plurality of cloud phones includes: storing the current bandwidths of the plurality of cloud phones in a database in response to receiving messages of the current bandwidths reported by the cloud phones; and in response to detecting that an update condition of the sorting table is satisfied, generating the sorting table according to a descending order of the current bandwidths of the plurality of cloud phones. The scheduler may passively receive bandwidths reported by the cloud phones, store them together without immediate sorting, and update the sorting table periodically. This reduces computational load and saves resources.

In some alternative implementations of the present embodiment, the message is sent by the cloud phone when the cloud phone detects that the current bandwidth exceeds a predetermined reporting threshold. This reduces the frequency of bandwidth reporting from the cloud phones and the frequency of updating the sorting table, thereby reducing computational load and saving resources.

In some alternative implementations of the present embodiment, the method further includes emptying the speed-limited table after a predetermined time. Emptying the speed limit is equivalent to removing the speed limit of the cloud phone whose speed is previously limited. Therefore, the speed limit can be automatically released in batch, and manual operation can be reduced.

In some alternative implementations of the present embodiment, the current bandwidth includes at least one of a local area network uplink bandwidth, a local area network downlink bandwidth, a public network uplink bandwidth, and a public network downlink bandwidth. Correspondingly, there may be four types of sorting tables and speed-limited tables, each targeting a different type of bandwidth for speed limiting. This allows for targeted speed limiting based on specific application scenarios, thereby fully improving resource utilization and achieving maximum throughput.

Still referring to FIG. 3, FIG. 3 is a schematic diagram of an application scenario of a method for scheduling a bandwidth of a cloud phone network according to the present embodiment. In the application scenario of FIG. 3, a specific flow is as follows.

In step 301, the cloud phones report the current bandwidths to the scheduler.

In step 302, the scheduler sorts the current bandwidths, updates the sorting table, and stores the updated sorting table in a database.

In step 303, the database periodically updates the speed-limited table based on the sorting table.

In step 304 when the switch bandwidth is insufficient, the scheduler queries the speed-limited table in the database;

In step 305, the scheduler returns the speed limit value in the speed-limited table to the cloud phone.

In step 306, the cloud phone applies speed limiting based on the speed limit values in the speed-limited table.

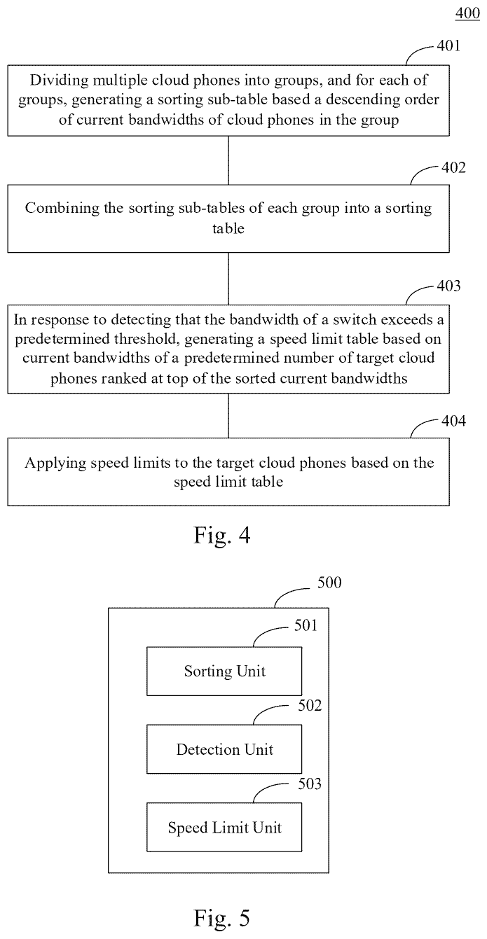

Referring further to FIG. 4, a flow 400 of a method for scheduling a bandwidth of a cloud phone network according to an embodiment is shown. A flow 400 of the method for scheduling a bandwidth of a cloud phone network includes the following steps.

Step 40 includes dividing multiple cloud phones into groups, and for each of the groups, generating a sorting sub-table based on a descending order of current bandwidths of cloud phones in the group.

In this embodiment, all cloud phones connected to a given switch may be divided into groups evenly. For example, 200 cloud phones may be divided into four groups. The 50 cloud phones of each group are sorted in descending order of current bandwidths to generate sub-sorting tables, resulting in a total of 4 sub-sorting tables. Grouping of the cloud phones may be done randomly, based on the chassis where the cloud phone is located in, or based on IP addresses.

Step 402 includes combining the sorting sub-tables of each group into a sorting table.

In the present embodiment, the sorting sub-tables may be combined into a sorting table without re-sorting all the cloud phones based on their current bandwidths, and the order of the cloud phones in the sub-tables may be retained.

Step 403 includes generating a speed-limited table based on current bandwidths of a predetermined number of target cloud phones ranked at top of the sorted current bandwidths in response to detecting that the bandwidth of the switch exceeds a predetermined threshold.

In this embodiment, when the switch bandwidth exceeds the predetermined threshold, speed limiting may be triggered. A predetermined number of cloud phones ranked at top of the sorted current bandwidths is selected from each sub-sorting table as target cloud phones, and the speed-limited table is generated based on the current bandwidths of the target cloud phones.

Step 404 includes applying speed limits to the target cloud phones based on the speed-limited table.

In the present embodiment, the speed limit value may be sent to the target cloud phone, and the target cloud phone sets the maximum network speed not to exceed the speed limit value in the speed-limited table through the built-in commands of the underlying operating system of the cloud phone.

By parallel sorting, the above embodiments can reduce sorting time and save computational resources.

In some alternative implementations of the present embodiment, dividing multiple cloud phones into groups includes: dividing multiple cloud phones into groups based on the network addresses of the cloud phones. Cloud phones with adjacent IP addresses may be grouped together. For example, by converting IP addresses from hexadecimal to decimal and then taking the modulus based on the number of groups, the cloud phones can be quickly and evenly grouped. This facilitates management, and the speed-limited table may also be set to limit speed based on IP addresses.

With further reference to FIG. 5, as an implementation of the method shown in each of the above figures, the present disclosure provides an embodiment of an apparatus for scheduling a bandwidth of a cloud phone network. The apparatus embodiment corresponds to the method embodiment shown in FIG. 2, and the apparatus can be specifically applied to various electronic devices.

As shown in FIG. 5, the apparatus 500 for scheduling a bandwidth of a cloud phone network according to the present embodiment includes a sorting unit 501, a detection unit 502, and a speed limiting unit 503. The sorting unit 501 is configured to sort current bandwidths of a plurality of cloud phones in a descending order; a detection unit 502 configured to generate a speed-limited table based on current bandwidths of a predetermined number of target cloud phones ranked at top of the sorted current bandwidths, in response to detecting that the switch bandwidth exceeds a predetermined threshold; and a speed limit unit 503 configured to apply speed limits to the target cloud phones according to the speed-limited table.

In the present embodiment, specific processing of the sorting unit 501, the detection unit 502, and the speed limit unit 503 of the apparatus 500 for scheduling a bandwidth of a cloud phone network may refer to step 201, step 202, and step 203 in the corresponding embodiment of FIG. 2.

In some alternative implementations of the present embodiment, the sorting unit 501 is further configured to generate a sorting table in the descending order of current bandwidths of the plurality of cloud phones.

In some alternative implementations of the present embodiment, the speed limit unit 503 is further configured to query the speed-limited table for a previously speed-limited cloud phone; and remove a speed limit of the previously speed-limited cloud phone, in response to not finding the previously speed-limited cloud phone.

In some alternative implementations of the present embodiment, the sorting unit 501 is further configured to divide the plurality of cloud phones into groups; for each of the groups, generate a sorting sub-table based on a descending order of current bandwidths of cloud phones in the group; and combine the sorting sub-tables of each group into the sorting table.

In some alternative implementations of the present embodiment, the sorting unit 501 is further configured to divide the plurality of cloud phones into the groups according to the network addresses of the cloud phones.

In some alternative implementations of the present embodiment, the detection unit 502 is further configured to map the current bandwidths of the target cloud phones to different levels based on bandwidth ranges, where a higher current bandwidth corresponds to a higher level; calculate speed limit values for the target cloud phones based on preset speed limit ratios for different levels and the current bandwidths, where the higher level corresponds to a higher speed limit ratio; and generate the speed-limited table based on the speed limit values of the target cloud phones.

In some alternative implementations of the present embodiment, the sorting unit 501 is further configured to obtain a list of cloud phones used by predetermined non-speed-limited users; identify cloud phones requiring speed limiting from the plurality of cloud phones based on the cloud phone list; and sort the cloud phones requiring speed limiting in the descending order of the current bandwidths of the cloud phones.

In some alternative implementations of the present embodiment, the sorting table includes user identifiers of the cloud phones; and the sorting unit is further configured to count numbers of respective cloud phones used by users according to the user identifiers; and adjust the sorting table in a descending order of the numbers of respective cloud phones.

In some alternative implementations of the present embodiment, the sorting table includes service priorities running on the cloud phone; and the sorting unit 501 is further configured to adjust the sorting table in an ascending order of the service priorities of the applications running on the cloud phones.

In some alternative implementations of the present embodiment, the detection unit 502 is further configured to generate a speed-limited table based on the current bandwidths of the predetermined number of target cloud phones ranked at top of the sorted current bandwidths, in response to detecting an arrival of a predicted traffic peak time.

In some alternative implementations of the present embodiment, the sorting unit 501 is further configured to back up the sorting table periodically; obtain the current bandwidths of the plurality of cloud phones and regenerate the sorting table in a descending order of the current bandwidths of the plurality of cloud phones; and remove a sorting table that reaching an expiration time.

In some alternative implementations of the present embodiment, the sorting unit 501 is further configured to store the current bandwidths of the plurality of cloud phones in a database in response to receiving messages of the current bandwidths reported by the cloud phones; and in response to detecting that an update condition of the sorting table is satisfied, generate the sorting table according to the descending order of the current bandwidths of the plurality of cloud phones.

In some alternative implementations of the present embodiment, the message is sent if the cloud phone detects that the current bandwidth is greater than a predetermined reporting threshold.

In some alternative implementations of the present embodiment, the detection unit 502 is further configured to empty the speed-limited table after a predetermined time.

In some alternative implementations of the present embodiment, the current bandwidth includes at least one of a local area network uplink bandwidth, a local area network downlink bandwidth, a public network uplink bandwidth, and a public network downlink bandwidth.

In the technical solution of the present disclosure, the processes of collecting, storing, using, processing, transmitting, providing, and disclosing the user personal information all comply with the provisions of the relevant laws and regulations, and do not violate the public order and good customs.

According to an embodiment of the present disclosure, the present disclosure also provides an electronic device, a readable storage medium, and a computer program product.

An electronic device including at least one processor; and a memory in communication with the at least one processor; where the memory stores instructions executable by the at least one processor to enable the at least one processor to perform the method of flow 200 or 400.

A non-transitory computer-readable storage medium storing computer instructions for causing the computer to perform the method of flow 200 or 400.

A computer program product includes a computer program that, when executed by a processor, implements the method described in flow 200 or 400.

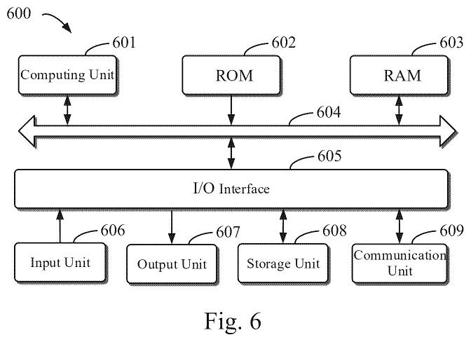

FIG. 6 illustrates a schematic block diagram of an example electronic device 600 that may be used to implement embodiments of the present disclosure. Electronic devices are intended to represent various forms of digital computers, such as laptop computers, desktop computers, worktables, personal digital assistants, servers, blade servers, mainframe computers, and other suitable computers. Electronic devices may also represent various forms of mobile devices, such as personal digital processing, cellular telephones, smart phones, wearable devices, and other similar computing devices. The components shown herein, their connections and relationships, and their functions are by way of example only and are not intended to limit the implementation of the disclosure described and/or claimed herein.

As shown in FIG. 6, the device 600 includes a computing unit 601, which may perform various appropriate actions and processes according to a computer program stored in a read-only memory (ROM) 602 or a computer program loaded into a random access memory (RAM) 603 from a storage unit 608. In RAM 603, various programs and data required for operation of the device 600 may also be stored. The computing unit 601, ROM 602 and RAM 603 are connected to each other via a bus 604. An input/output (I/O) interface 605 is also connected to bus 604.

A plurality of components in the device 600 are connected to the I/O interface 605, including an input unit 606, such as a keyboard, a mouse, and the like; an output unit 607, for example, various types of displays, speakers, and the like; a storage unit 608, such as a magnetic disk, an optical disk, or the like; and a communication unit 609, such as a network card, a modem, or a wireless communication transceiver. The communication unit 609 allows the device 600 to exchange information/data with other devices over a computer network such as the Internet and/or various telecommunications networks.

The computing unit 601 may be various general-purpose and/or special-purpose processing components having processing and computing capabilities. Some examples of computing units 601 include, but are not limited to, central processing units (CPUs), graphics processing units (GPUs), various specialized artificial intelligence (AI) computing chips, various computing units that run machine learning model algorithms, digital signal processors (DSPs), and any suitable processors, controllers, microcontrollers, and the like. The computing unit 601 performs various methods and processes described above, such as a method for scheduling a bandwidth of a cloud phone network. For example, in some embodiments, the method for scheduling a bandwidth of a cloud phone network may be implemented as a computer software program tangibly embodied in a machine-readable medium, such as storage unit 608. In some embodiments, some or all of the computer program may be loaded and/or installed on the device 600 via the ROM 602 and/or the communication unit 609. When the computer program is loaded into the RAM 603 and executed by the computing unit 601, one or more steps of the method for scheduling a bandwidth of a cloud phone network described above may be performed. Alternatively, in other embodiments, the computing unit 601 may be configured to perform a method for scheduling a bandwidth of a cloud phone network by any other suitable means (e.g., by means of firmware).

The various embodiments of the systems and techniques described above herein may be implemented in a digital electronic circuit system, an integrated circuit system, a field programmable gate array (FPGA), an application specific integrated circuit (ASIC), a special purpose standard product (ASSP), a system on a system on a chip (SOC), a load programmable logic device (CPLD), computer hardware, firmware, software, and/or combinations thereof. These various embodiments may include being implemented in one or more computer programs that may execute and/or interpret on a programmable system including at least one programmable processor, which may be a dedicated or general purpose programmable processor, may receive data and instructions from a memory system, at least one input device, and at least one output device, and transmit the data and instructions to the memory system, the at least one input device, and the at least one output device.

The program code for carrying out the methods of the present disclosure may be written in any combination of one or more programming languages. These program codes may be provided to a processor or controller of a general purpose computer, special purpose computer, or other programmable data processing apparatus such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include one or more line-based electrical connections, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination of the foregoing.

To provide interaction with a user, the systems and techniques described herein may be implemented on a computer having a display device (e.g., a CRT (cathode ray tube) or LCD (liquid crystal display) monitor) for displaying information to the user; and a keyboard and a pointing device (e.g., a mouse or a trackball) through which a user can provide input to a computer. Other types of devices may also be used to provide interaction with a user; For example, the feedback provided to the user may be any form of sensory feedback (e.g., visual feedback, auditory feedback, or tactile feedback); And input from the user may be received in any form, including acoustic input, speech input, or tactile input.

The systems and techniques described herein may be implemented in a computing system including a background component (e.g., as a data server), or a computing system including a middleware component (e.g., an application server), or a computing system including a front-end component (e.g., a user computer having a graphical user interface or a web browser through which a user may interact with embodiments of the systems and techniques described herein), or a computing system including any combination of such background component, middleware component, or front-end component. The components of the system may be interconnected by any form or medium of digital data communication (e.g., a communication network). Examples of communication networks include a local area network (LAN), a wide area network (WAN), and the Internet.

The computer system may include a client and a server. The client and server are typically remote from each other and typically interact through a communication network. The relationship between the client and the server is generated by a computer program running on the corresponding computer and having a client-server relationship with each other. The server may be a cloud server, a server of a distributed system, or a server incorporating a chain of blocks.

It is to be understood that the steps of reordering, adding or deleting may be performed using the various forms shown above. For example, the steps described in the present disclosure may be performed in parallel or sequentially or in a different order, so long as the desired results of the technical solution disclosed in the present disclosure can be realized, and no limitation is imposed herein.

The foregoing detailed description is not intended to limit the scope of the present disclosure. It will be appreciated by those skilled in the art that various modifications, combinations, sub-combinations, and substitutions may be made depending on design requirements and other factors. Any modifications, equivalents, and modifications that fall within the spirit and principles of the disclosure are intended to be included within the scope of protection of the disclosure.

What is claimed is:

1. A method for scheduling a bandwidth of a cloud phone network, comprising:
sorting current bandwidths of a plurality of cloud phones in a descending order;
generating a speed-limited table based on current bandwidths of a predetermined number of target cloud phones ranked at top of the sorted current bandwidths, in response to detecting that a switch bandwidth exceeds a predetermined threshold; and
applying speed limits to the target cloud phones according to the speed-limited table.

2. The method according to claim 1, wherein the sorting the current bandwidths of the plurality of cloud phones in the descending order comprises:
generating a sorting table in the descending order of current bandwidths of the plurality of cloud phones.

3. The method according to claim 1, wherein applying speed limits to the target cloud phones according to the speed-limited table comprises:
querying the speed-limited table for a previously speed-limited cloud phone; and
removing a speed limit of the previously speed-limited cloud phone, in response to not finding the previously speed-limited cloud phone in the speed-limited table.

4. The method according to claim 2, wherein the generating the sorting table in the descending order of current bandwidths of the plurality of cloud phones comprises:
dividing the plurality of cloud phones into groups;
for each of the groups, generating a sorting sub-table based on a descending order of current bandwidths of cloud phones in the group; and
combining the sorting sub-tables of the groups into the sorting table.

5. The method according to claim 4, wherein dividing the plurality of cloud phones into the groups comprises:
dividing the plurality of cloud phones into the groups according to the network addresses of the cloud phones.

6. The method according to claim 1, wherein the generating the speed-limited table based on the current bandwidths of the predetermined number of target cloud phones ranked at top of the sorted current bandwidths comprises:
mapping the current bandwidths of the target cloud phones to different levels based on bandwidth ranges, wherein a higher current bandwidth corresponds to a higher level;
calculating speed limit values for the target cloud phones based on preset speed limit ratios for different levels and the current bandwidths, wherein the higher level corresponds to a higher speed limit ratio; and
generating the speed-limited table based on the speed limit values of the target cloud phones.

7. The method according to claim 1, wherein the sorting current bandwidths of a plurality of cloud phones in the descending order comprises:
obtaining a list of cloud phones used by predetermined non-speed-limited users;
identifying cloud phones requiring speed limiting from the plurality of cloud phones based on the cloud phone list; and
sorting the cloud phones requiring speed limiting in the descending order of the current bandwidths of the cloud phones.

8. The method according to claim 2, wherein the sorting table comprises user identifiers of the cloud phones; and
the method further comprises:
counting numbers of respective cloud phones used by users according to the user identifiers; and
adjusting the sorting table in a descending order of the numbers of respective cloud phones.

9. The method according to claim 2, wherein the sorting table comprises service priorities of applications running on the cloud phones; and
the method further comprises:
adjusting the sorting table in an ascending order of the service priorities of the applications running on the cloud phones.

10. The method according to claim 1, wherein the method further comprises:
generating a speed-limited table based on the current bandwidths of the predetermined number of target cloud phones ranked at top of the sorted current bandwidths, in response to detecting an arrival of a predicted traffic peak time.

11. The method according to claim 2, wherein the method further comprises:
backing up the sorting table periodically;
obtaining the current bandwidths of the plurality of cloud phones and regenerating the sorting table in a descending order of the current bandwidths of the plurality of cloud phones; and
removing a sorting table reaching an expiration time.

12. The method according to claim 2, wherein the generating the sorting table in the descending order of the current bandwidths of the plurality of cloud phones comprises:
storing the current bandwidths of the plurality of cloud phones in a database, in response to receiving messages of the current bandwidths reported by the cloud phones; and
in response to detecting that an update condition of the sorting table is satisfied, generating the sorting table according to the descending order of the current bandwidths of the plurality of cloud phones.

13. The method according to claim 12, wherein the message is sent if the cloud phone detects that the current bandwidth is greater than a predetermined reporting threshold.

14. The method according to claim 1, wherein the method further comprises:
emptying the speed-limited table after a predetermined time.

15. The method according to claim 1, wherein the current bandwidth comprises at least one of a local area network uplink bandwidth, a local area bandwidth, a public network uplink bandwidth, and a public network downlink bandwidth.

16. An electronic device comprising:
at least one processor; and
a memory in communication with the at least one processor;
wherein the memory stores instructions executable by the at least one processor to cause the at least one processor to perform operations comprising:
sorting current bandwidths of a plurality of cloud phones in a descending order;
generating a speed-limited table based on current bandwidths of a predetermined number of target cloud phones ranked at top of the sorted current bandwidths, in response to detecting that a switch bandwidth exceeds a predetermined threshold; and
applying speed limits to the target cloud phones according to the speed-limited table.

17. The electronic device according to claim 16, wherein the sorting the current bandwidths of the plurality of cloud phones in the descending order comprises:
generating a sorting table in the descending order of current bandwidths of the plurality of cloud phones.

18. The electronic device according to claim 16, wherein applying speed limits to the target cloud phones according to the speed-limited table comprises:
querying the speed-limited table for a previously speed-limited cloud phone; and
removing a speed limit of the previously speed-limited cloud phone, in response to not finding the previously speed-limited cloud phone in the speed-limited table.

19. The electronic device according to claim 17, wherein the generating the sorting table in the descending order of current bandwidths of the plurality of cloud phones comprises:
dividing the plurality of cloud phones into groups;
for each of the groups, generating a sorting sub-table based on a descending order of current bandwidths of cloud phones in the group; and
combining the sorting sub-tables of the groups into the sorting table.

20. A non-transitory computer-readable storage medium storing computer instructions for causing the computer to perform
operations comprising:
sorting current bandwidths of a plurality of cloud phones in a descending order;
generating a speed-limited table based on current bandwidths of a predetermined number of target cloud phones ranked at top of the sorted current bandwidths, in response to detecting that a switch bandwidth exceeds a predetermined threshold; and
applying speed limits to the target cloud phones according to the speed-limited table.
